(19) United States
(12) Patent Application Publication
(10) Pub. No.: US 2025/0355384 A1
(43) Pub. Date: Nov. 20, 2025

(54) FIXING DEVICE, IMAGE FORMING APPARATUS, CONTROL METHOD, AND STORAGE MEDIUM

(71) Applicant: Konica Minolta, Inc., Tokyo (JP)

(72) Inventors: Taiga MIYAMOTO, Tokyo (JP); Yu YUKAWA, Kawasaki-shi (JP)

(21) Appl. No.: 19/208,793

(22) Filed: May 15, 2025

(30) Foreign Application Priority Data
May 17, 2024 (JP) 2024-080897

(51) Int. Cl. G03G 15/20; G03G 15/16

(52) U.S. Cl. CPC G03G 15/2028; G03G 15/1615; G03G 15/2032; G03G 15/2064; G03G 2215/00738; G03G 2215/00742; G03G 2215/2032

(57) ABSTRACT

A fixing device pressurizes a sheet having a toner image to fix the toner image, and includes a first roller, a second roller that faces the first roller to form a fixing nip and has a higher surface hardness than the first roller, an entrance guide that is rotatable around a rotation axis parallel to the second roller and guides the sheet that is about to enter the fixing nip, and a hardware processor that controls a rotation position of the entrance guide around the rotation axis based on sheet stiffness information on a hardness of the sheet.

### CROSS REFERENCE TO RELATED APPLICATIONS

The present invention claims priority under 35 U.S.C. § 119 to Japanese Patent Application No. 2024-080897, filed on May 17, 2024, the entire content of which is incorporated herein by reference.

### BACKGROUND OF THE INVENTION

### Technical Field

The present invention relates to a fixing device that fixes a toner image onto a sheet, an image forming apparatus, a control method, and a storage medium.

### Description of Related Art

In an image forming apparatus, a sheet to which an unfixed toner image has been transferred is heated and pressurized at a fixing nip, so that the toner image is fixed to the sheet.

In Japanese Unexamined Patent Publication No. 2017-181760, in conjunction with deformation of a fixing nip, an entrance guide that guides a sheet to the fixing nip is moved to a position corresponding to the fixing nip after the deformation. Thus, the sheet is appropriately guided to the fixing nip whose shape has been changed.

### SUMMARY OF THE INVENTION

However, in the above-described conventional technology, when the leading end of the sheet hits a hard fixing roller, the sheet receives an impact. When the sheet receives the impact, image unevenness may occur in a direction perpendicular to a conveyance direction at a transfer section on the upstream side of a fixing section.

This impact can be suppressed by guiding the sheet such that the leading end of the sheet enters a position close to the fixing nip. However, if the sheet does not smoothly enter the fixing nip, sheet wrinkling or the like may occur.

The present invention has been made in view of the above circumstances, and an object of the present invention is to improve print quality.

To achieve at least one of the abovementioned objects, according to an aspect of the present invention, a fixing device reflecting one aspect of the present invention pressurizes a sheet having a toner image to fix the toner image, and includes:
a first roller;
a second roller that faces the first roller to form a fixing nip and has a higher surface hardness than the first roller;
an entrance guide that is rotatable around a rotation axis parallel to the second roller and guides the sheet that is about to enter the fixing nip; and
a hardware processor that controls a rotation position of the entrance guide around the rotation axis based on sheet stiffness information on a hardness of the sheet.

According to an aspect of the present invention, an image forming apparatus reflecting one aspect of the present invention includes:
an image former that forms the toner image;
a transferrer that transfers the toner image formed by the image former onto the sheet; and
the fixing device.

According to an aspect of the present invention, a control method reflecting one aspect of the present invention is a control method of a fixing device including a first roller, a second roller that faces the first roller to form a fixing nip and has a higher surface hardness than the first roller, and an entrance guide that is rotatable around a rotation axis parallel to the second roller and guides a sheet that is about to enter the fixing nip, the control method including:
controlling a rotation position of the entrance guide around the rotation axis based on sheet stiffness information on a hardness of the sheet.

According to an aspect of the present invention, a non-transitory computer-readable storage medium reflecting one aspect of the present invention stores a program causing, of a fixing device including a first roller, a second roller that faces the first roller to form a fixing nip and has a higher surface hardness than the first roller, and an entrance guide that is rotatable around a rotation axis parallel to the second roller and guides a sheet that is about to enter the fixing nip, a computer to:
control a rotation position of the entrance guide around the rotation axis based on sheet stiffness information on a hardness of the sheet.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein: FIG. 1 is a diagram illustrating a schematic configuration of an image forming apparatus according to an embodiment;

FIG. 2 is a block diagram illustrating a schematic control configuration of the image forming apparatus according to the embodiment;

FIG. 3 is a diagram illustrating a fixing section according to the embodiment;

FIG. 4 is a perspective view illustrating an entrance guide and a support member according to the embodiment;

FIG. 5 is a perspective view illustrating the support member, a cam member, and a motor according to the embodiment;

FIG. 6A is a diagram illustrating the entrance guide and the support member at a first rotation position;

FIG. 6B is a diagram illustrating the entrance guide and the support member at a second rotation position; and

FIG. 7 is a diagram for explaining a modification example of the embodiment.

### DETAILED DESCRIPTION

Hereinafter, one or more embodiments of the present invention will be described with reference to the drawings. However, the scope of the invention is not limited to the disclosed embodiments.

### [Overall Configuration of Image Forming Apparatus]

FIG. 1 is a diagram illustrating an overall configuration of an image forming apparatus 1 according to the present embodiment.

As illustrated in FIG. 1, the image forming apparatus 1 according to the present embodiment performs image formation using an electrophotographic process, and reads an image from a document and forms (transfers or prints) the image on a sheet S. Furthermore, the image forming apparatus 1 receives job data including image data in a page description language (PDL) format, setting information, and the like from an external client terminal via a network. Next, the image forming apparatus 1 forms an image on a sheet S based on the job data. The client terminal is, for example, a PC, a tablet terminal, a smartphone, or the like.

Specifically, the image forming apparatus 1 includes an image reading section 2, an image forming section 3 (image former), an intermediate transfer section 4, a sheet feed section 5, a sheet conveyance section 6, a secondary transfer section 7 (transferrer), and a fixing section 8.

The image reading section 2 reads a document with a scanning exposure section 21 and outputs an image information signal (image data). That is, the image of the document placed on a document plate 22 is scanned and exposed by an optical system constituting the scanning exposure section 21 and is read by a line image sensor.

The image forming section 3 includes five image forming sections 31 that form toner images of respective colors of yellow (Y), magenta (M), cyan (C), black (K), and a special color (Z) (e.g., white (W)).

Each image forming section 31 forms a toner image of a color on a photoreceptor 32 and primarily transfers the toner image onto an intermediate transfer belt 41. Each image forming section 31 includes the photoreceptor 32, a charging device 33, an exposure device 34, a developing device 35, and a cleaning section 36.

The photoreceptor 32 is a drum-shaped image bearing member that bears an image (toner image) on the surface thereof. The photoreceptor 32 is constituted by an organic photoreceptor in which a photosensitive layer made of resin containing an organic photoconductor is formed on the outer circumferential surface of a drum-shaped metal substrate and is rotationally driven counterclockwise in FIG. 1.

The charging device 33 uniformly charges the surface of the photoreceptor 32 to a certain potential.

The exposure device 34 exposes a non-image region of the photoreceptor 32 based on image data from the image reading section 2 and forms an electrostatic latent image in an image region of the photoreceptor 32. The image data is not limited to the data output from the image reading section 2, but may be, for example, data received from an external apparatus such as the client terminal.

The developing device 35 supplies toner, which is a developer, onto the electrostatic latent image formed on the photoreceptor 32 to form a toner image on the photoreceptor 32.

The cleaning section 36 removes toner remaining on the surface of the photoreceptor 32 by, for example, a blade method.

The intermediate transfer section 4 includes the intermediate transfer belt 41 and primary transfer rollers 42.

The intermediate transfer belt 41 is a belt-like image bearing member that is stretched around a plurality of rollers, bears an image (toner image) on its surface, and conveys the image in a movement direction T thereof.

The primary transfer rollers 42 are disposed opposite the respective photoreceptors 32 with the intermediate transfer belt 41 therebetween. The primary transfer rollers 42 press the intermediate transfer belt 41 against the photoreceptors 32 facing the primary transfer rollers 42 and primarily transfer the toner images formed on the photoreceptors 32 to the intermediate transfer belt 41.

The sheet feed section 5 includes a plurality of trays 51 for storing sheets S as recording media. In the trays 51, for example, sheets S different in size, paper quality, paper type, and the like are stored. Each sheet S is fed from the sheet feed section 5 onto a conveyance path of the sheet conveyance section 6.

The sheet conveyance section 6 includes a plurality of rollers 61 and conveys the sheet S sent from the sheet feed section 5. The sheet S supplied from one of the trays 51 of the sheet feed section 5 is conveyed to the secondary transfer section 7 via a registration roller 62.

The sheet conveyance section 6 includes a sheet reversing section 63. The sheet reversing section 63 reverses the sheet S on which the image has been fixed by the fixing section 8.

The secondary transfer section 7 includes a pair of secondary transfer rollers 71.

The secondary transfer rollers 71 come into pressure contact with each other via the intermediate transfer belt 41 to form a secondary transfer nip therebetween. The secondary transfer nip brings the sheet S conveyed by the sheet conveyance section 6 into contact with the intermediate transfer belt 41, and secondarily transfers the toner image borne on the surface of the intermediate transfer belt 41 to the sheet S.

The fixing section 8 is arranged on the downstream side (ejection side) of the secondary transfer section 7 in a conveyance direction of the sheet S. The fixing section 8 heats and pressurizes the conveyed sheet S to fix the toner image transferred onto the sheet S.

Details of the configuration of the fixing section 8 will be described later.

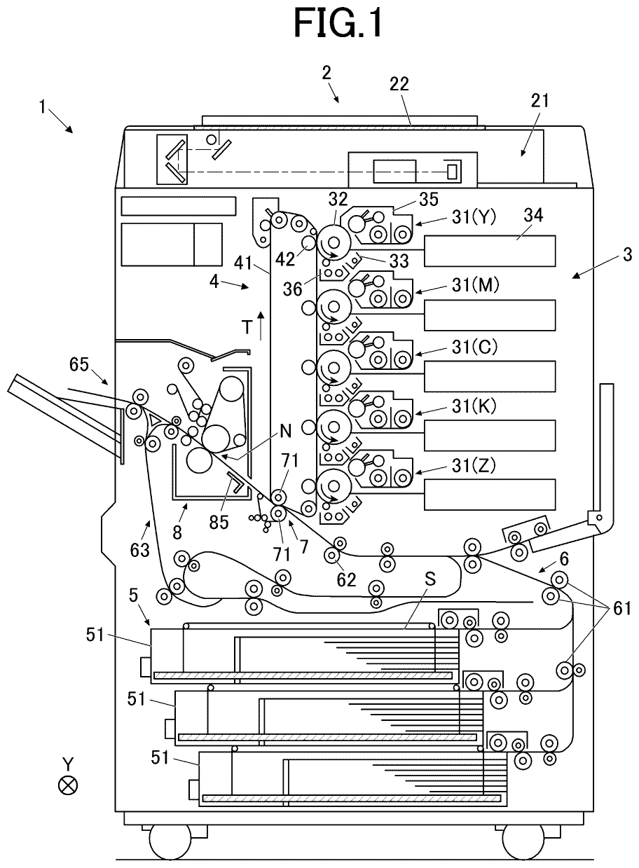

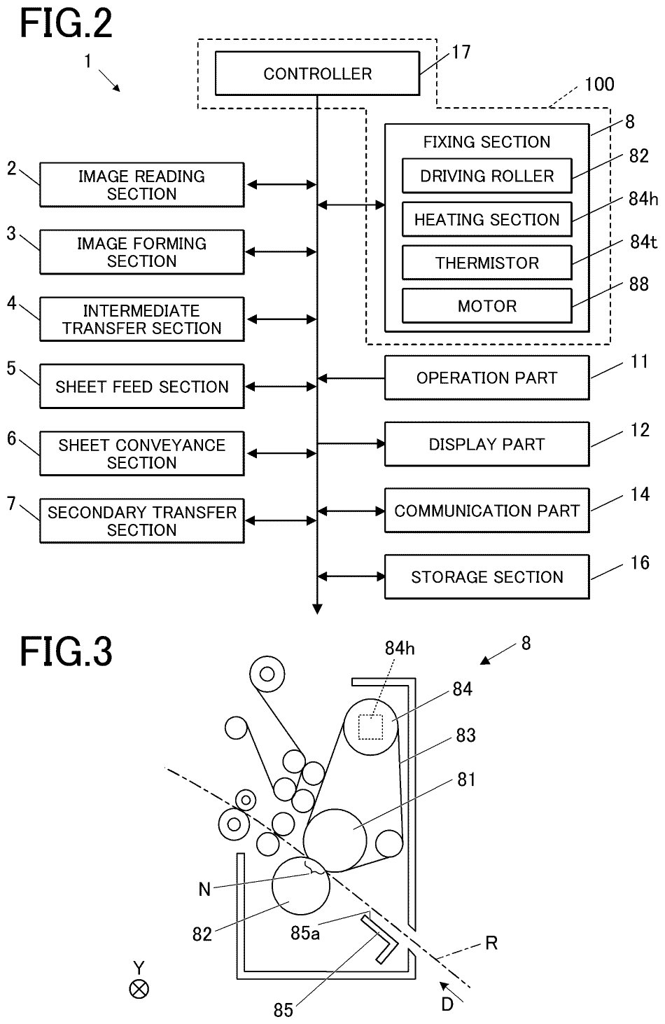

FIG. 2 is a block diagram illustrating a schematic control configuration of the image forming apparatus 1.

As illustrated in FIG. 2, the image forming apparatus 1 includes, in addition to the above components, an operation part 11 (setter), a display part 12, a communication part 14, a storage section 16, and a controller 17 (hardware processor). A fixing device 100 according to the present invention includes the fixing section 8 and the controller 17.

The operation part 11 is an operation part with which an operator makes various operations for activating the image forming apparatus 1 and includes an input device such as a mouse and/or a keyboard, for example.

The display part 12 is, for example, a liquid crystal display, an organic electroluminescence display, or another display. The display part 12 displays various types of information on the basis of display signals from the controller 17. The display part 12 may be a touch screen that also serves as at least part of the operation part 11.

The communication part 14 is connected to the client terminal such as a PC via the network and transmits and receives various types of data such as image data and job data.

The storage section 16 is a memory including, for example, a random access memory (RAM), a read only memory (ROM), and/or the like. The storage section 16 stores various programs including a program for executing rotation control of an entrance guide 85 described later and various data and also functions as a work area for the controller 17.

The controller 17 is constituted by, for example, a central processing unit (CPU) or the like, and controls the operation of each component of the image forming apparatus 1. Specifically, the controller 17 loads programs stored in advance in the storage section 16 on the basis of the contents or the like of operations made with the operation part 11, and executes various processes in cooperation with the loaded programs.

### [Overall Configuration of Fixing Section]

FIG. 3 is a diagram illustrating the fixing section 8.

As illustrated in FIG. 3, the fixing section 8 includes a pressure roller (first roller) 81, a driving roller (second roller) 82, a fixing belt 83, and a heating roller 84. The pressure roller 81, the driving roller 82, and the heating roller 84 are disposed along a depth direction Y (direction perpendicular to the sheet surface of FIG. 3) of the image forming apparatus 1.

The pressure roller 81 and the driving roller 82 come into pressure contact with each other via the fixing belt 83 to form a fixing nip N therebetween.

The pressure roller 81 is disposed above the driving roller 82. The driving roller 82 has a surface hardness higher than that of the pressure roller 81. Specifically, the driving roller 82 is hardly deformed by the pressing force from the pressure roller 81. On the other hand, the pressure roller 81 has an elastic layer of, for example, silicone rubber or the like on the outer circumference of a base body. Therefore, at the fixing nip N, the elastic layer of the pressure roller 81 is pressed and deformed by the driving roller 82, thereby coming into contact with the driving roller 82.

The pressure roller 81 may be in the form of a pad rather than a roller.

The fixing belt 83 is an endless belt stretched around a plurality of rollers including the pressure roller 81 and the heating roller 84. The fixing belt 83 is sandwiched between the pressure roller 81 and the driving roller 82 and forms the fixing nip N with the driving roller 82. The fixing belt 83 is rotated by the rotation of the driving roller 82 in a state in which the fixing belt 83 is sandwiched between the pressure roller 81 and the driving roller 82.

The heating roller 84 is, for example, a metal pipe. A heating section 84h (heater) is fixed inside the heating roller 84.

The heating section 84h is, for example, a heating element such as a halogen heater, and heats the fixing belt 83 stretched around the heating roller 84.

The heating roller 84 is also provided with a thermistor 84t (see FIG. 2). The thermistor 84t detects the temperature of the heating roller 84 (or fixing belt 83) and outputs the detected temperature to the controller 17.

The heating roller 84 may be configured to be rotationally driven. By the heating roller 84 being rotationally driven, the tension of the fixing belt 83 from the fixing nip N to the heating roller 84 increases. Thus, in the rotation direction of the fixing belt 83, the curvature of the exit of the fixing nip N can be increased, and the separation performance of the sheet S can be improved.

To the fixing section 8, the sheet S to which the toner image has been transferred at the secondary transfer section 7 is conveyed on a conveyance path R along the conveyance direction D in a state in which the surface on which the toner image has been transferred (fixing target surface) faces the pressure roller 81 side, and passes through the fixing nip N in the fixing section 8.

At the time, heat of the fixing belt 83 heated by the heating roller 84 is transmitted to the sheet S, so that the toner image on the sheet S is heat-fixed.

Thus, the sheet S passing through the fixing nip N is pressurized by the pressure roller 81 and the driving roller 82 and heated by the heat of the fixing belt 83, so that the toner image is fixed thereon.

The sheet S onto which the image has been fixed by the fixing section 8 is ejected to the outside of the image forming apparatus 1 from a sheet ejection section 65 (see FIG. 1).

### [Entrance Guide of Fixing Section]

In the fixing section 8, an entrance guide 85 that guides the sheet S that is about to enter the fixing nip N is arranged.

The entrance guide 85 is arranged on the upstream side of the fixing nip N in the conveyance direction D and on the obliquely lower side thereof. The entrance guide 85 is formed in a substantially plate shape, and has, on the upper side, a planar guide surface 85a along the depth direction Y and the conveyance direction D.

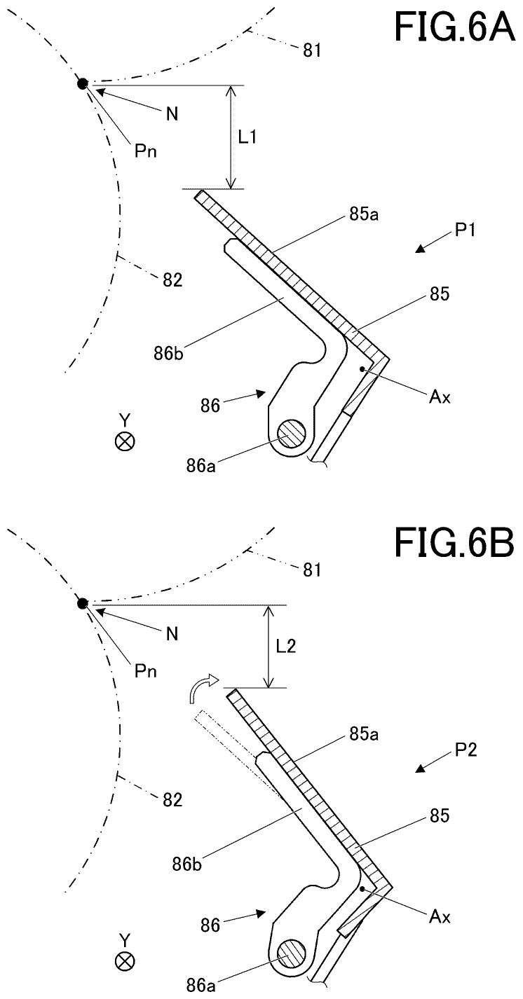

The entrance guide 85 is supported so as to be rotatable around a rotation axis Ax (see FIG. 6A) parallel to the depth direction Y. The entrance guide 85 is biased to, about the rotation axis Ax, a rotation direction in which the end on the downstream side in the conveyance direction D is lowered in position (counterclockwise in FIG. 3).

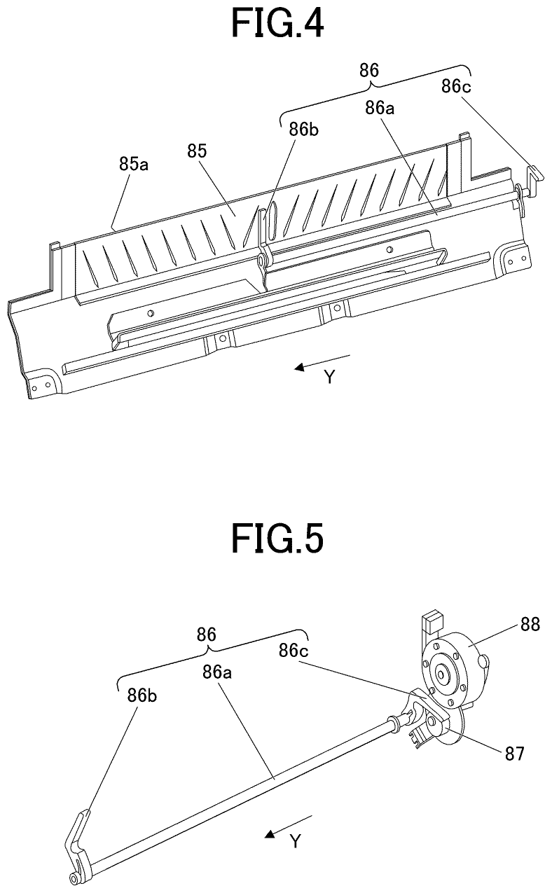

Specifically, as illustrated in FIG. 4 and FIG. 5, the entrance guide 85 is supported by a support member 86 disposed on the back surface side (lower side) of the guide surface 85a.

The support member 86 includes a shaft 86a parallel to the depth direction Y, and a support portion 86b (support) and a follower portion 86c at both ends of the shaft 86a.

The support portion 86b is provided at one end of the shaft portion 86a, and in contact with the center part in the depth direction Y on the back side of the guide surface 85a of the entrance guide 85.

The follower portion 86c is provided at the other end of the shaft 86a and is connected to a motor 88 via a cam member 87 (cam). When the cam member 87 is rotated by the drive of the motor 88, the shaft 86a of the support member 86 is rotated, and the support portion 86b rotates the entrance guide 85 around the rotation axis Ax (see FIG. 6A and FIG. 6B). More specifically, during the rotation in a rotation direction in which the end of the entrance guide 85 on the downstream side in the conveyance direction D is increased in position, the support portion 86b of the support member 86 presses and rotates the entrance guide 85. On the other hand, during the rotation in the opposite direction, as the support portion 86b rotates in a direction away from the entrance guide 85, the entrance guide 85 rotates in the same direction so as to follow the support portion 86b by biasing force applied in advance.

The entrance guide 85 is attachable to and detachable from the fixing section 8 together with the support member 86, the cam member 87, and the motor 88. Therefore, when the guide surface 85a is damaged or toner adheres thereto, or when the support member 86 malfunctions, they can be integrally replaced as a unit.

The configuration for rotating the entrance guide 85 is not particularly limited to the above-described configuration. For example, a configuration in which a solenoid is used to move the entrance guide 85, a configuration in which gears are meshed to rotate the entrance guide 85, or the like may be adopted. Alternatively, the entrance guide 85 may be directly rotated by a motor, a cam, or the like, not via the support member 86.

### [Rotation Control of Entrance Guide]

FIG. 6A and FIG. 6B are diagrams illustrating the entrance guide 85 and the support member 86 at a first rotation position P1 and a second rotation position P2, which will be described later.

During the operation of the image forming apparatus 1, the controller 17 drives the motor 88 based on the basis weight of the sheet S to control the rotation position of the entrance guide around the rotation axis Ax. The basis weight of the sheet S is input in advance as a profile setting of the sheet S by the user operating the operation part 11 and is stored in the storage section 16.

Specifically, as the basis weight of the sheet S is smaller, the controller 17 controls the rotation position of the entrance guide 85 such that the sheet S enters (reaches) a position more away from the entrance position Pn of the fixing nip N toward the driving roller 82.

The rotation position of the entrance guide 85 may be changed stepwise or continuously.

For example, in the present embodiment, the rotation position of the entrance guide 85 is switched in two levels. When the basis weight of the sheet S is less than 256 g/m², the rotation position of the entrance guide 85 is set to the first rotation position P1 (FIG. 6A). The first rotation position P1 is a rotation position that allows the leading end of the sheet S to contact the driving roller 82 before entering the fixing nip N. On the other hand, when the basis weight of the sheet S is 256 g/m² or more, the rotation position of the entrance guide 85 is changed from the first rotation position P1 to the second rotation position P2 (FIG. 6B). The second rotation position P2 is a rotation position that allows the leading end of the sheet S to enter a position closer to (the entrance position Pn of) the fixing nip N as compared with the first rotation position P1. At the first rotation position P1, the vertical distance (height) L1 from the entrance position Pn of the fixing nip N to the tip of the entrance guide 85 is about 23 mm. At the second rotation position P2, the vertical distance (height) L2 from the entrance position Pn of the fixing nip N to the tip of the entrance guide 85 is about 18 mm.

As a result, in the case where the basis weight of the sheet S is small (stiffness is low), the sheet S is conveyed to the fixing nip N in a state in which the leading end of the sheet S contacts the driving roller 82 and is guided along the driving roller 82 accordingly. Therefore, the sheet S appropriately enters the fixing nip N without sheet wrinkling or sheet jam.

On the other hand, in the case where the basis weight of the sheet S is large (stiffness is high), when the leading end of the sheet S hits the hard driving roller 82, the sheet S receives an impact. When the sheet S receives an impact, shock noise occurs at the secondary transfer section 7 in the middle of the sheet S, which may cause image unevenness in a direction perpendicular to the conveyance direction D. Therefore, in this case, the rotation position of the entrance guide 85 is changed so that the leading end of the sheet S enters the fixing nip N directly, as compared with the case where the stiffness of the sheet S is low. Thus, shock noise at the secondary transfer section 7 can be suppressed.

That is, when the stiffness of the sheet S is low, the rotation position of the entrance guide 85 is controlled such that the leading end of the sheet S contacts the driving roller 82 at a predetermined angle, for example. From there, the rotation position of the entrance guide 85 is controlled such that as the stiffness of the sheet S is higher, the entry position of the leading end of the sheet S is closer to the fixing nip N. When the sheet S has high stiffness, the leading end of the sheet S may contact the pressure roller 81, which has the elastic layer on its surface.

The parameter used for the rotation control of the entrance guide 85 is sheet stiffness information on the hardness of the sheet S, which includes at least one of the basis weight, the stiffness and the thickness of the sheet S, for example. The sheet stiffness information may be set (input) in advance by the user operating the operation part 11 or may be detected by various sensors each time a printing process is performed.

### [Technical Effects of Present Embodiment]

As described above, according to the present embodiment, the rotation position of the entrance guide 85, which guides the sheet S that is about to enter the fixing nip N, around the rotation axis Ax is controlled based on the sheet stiffness information.

Thus, the sheet S can be made to enter the fixing nip N smoothly. Therefore, image unevenness, sheet wrinkling, and the like, which may occur when the sheet S does not smoothly enter the fixing nip N, can be suppressed, and print quality can be improved.

According to the present embodiment, in the case where the sheet stiffness information is less than a threshold value, the rotation position of the entrance guide 85 is set to the first rotation position P1 that allows the leading end of the sheet S to contact the driving roller 82 before entering the fixing nip N. On the other hand, in the case where the sheet stiffness information is equal to or more than the threshold value, the rotation position of the entrance guide 85 is set to the second rotation position P2 that allows the leading end of the sheet S to enters the position closer to the fixing nip N, as compared with the first rotation position P1.

Thus, when the stiffness of the sheet S is low, the sheet S is conveyed to the fixing nip N after the leading end of the sheet S hits the driving roller 82. Therefore, the sheet S appropriately enters the fixing nip N without sheet wrinkling or sheet jam.

On the other hand, when the stiffness of the sheet S is high, the sheet S enters the fixing nip N directly, as compared with the first rotation position P1. Therefore, the impact caused by the leading end of the sheet S hitting the driving roller 82 is suppressed, and image unevenness in the direction perpendicular to the conveyance direction generated at the secondary transfer section 7 due to this impact is suppressed.

Therefore, the print quality can be improved.

Furthermore, according to the present embodiment, the entrance guide 85 is configured to be detachable and attachable.

Therefore, when the guide surface 85a is damaged or toner adheres thereto, the entire entrance guide 85 can be replaced with a new one.

Furthermore, according to the present embodiment, the sheet stiffness information is set based on a user operation on the operation part 11.

Thus, the user can appropriately set the stiffness of the sheet S to adjust the rotation position of the entrance guide 85.

### [Others]

Although an embodiment of the present invention has been described above, embodiments to which the present invention can be applied are not limited to the above-described embodiment or modification example and can be appropriately modified without departing from the scope of the present invention.

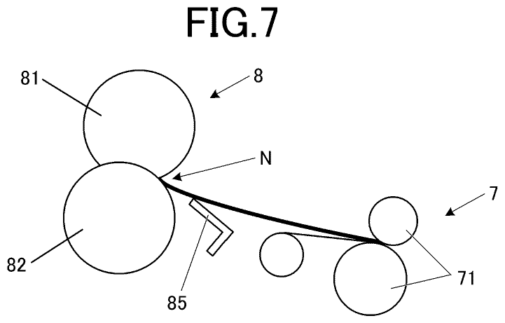

For example, as illustrated in FIG. 7, in the case of, for example, a specific paper type having high stiffness, immediately after entering (reaching) the fixing nip N, the sheet S cannot smoothly advance and is bent and accordingly shock noise may occur at the secondary transfer section 7 on the upstream side. In this case, it may be difficult to eliminate the shock noise by the above-described rotation control of the entrance guide 85.

Therefore, in this case, the nip pressure of the fixing nip N may be reduced, the transfer pressure of the secondary transfer section 7 may be increased, or both of them may be performed.

In order to adjust the nip pressure, for example, the driving roller 82 is configured to be movable in a direction in which the driving roller 82 contacts and separates from the pressure roller 81. To lower the nip pressure, the driving roller 82 is separated from the pressure roller 81.

In order to adjust the transfer pressure with which the toner image is transferred onto the sheet S at the secondary transfer section 7, for example, one of the secondary transfer rollers 71 is configured to be movable in a direction in which the one contacts or separates from the other. To increase the transfer pressure, the secondary transfer rollers 71 are made to come close to each other.

This adjustment is performed as necessary, for example, when the user checks the output image quality and determines that image unevenness due to shock noise has occurred.

Although embodiments of the present invention have been described and illustrated in detail, the disclosed embodiments are made for purposes of illustration and example only and not limitation. The scope of the present invention should be interpreted by terms of the appended claims.

What is claimed is:

1. A fixing device that pressurizes a sheet having a toner image to fix the toner image, the fixing device comprising:
a first roller;
a second roller that faces the first roller to form a fixing nip and has a higher surface hardness than the first roller;
an entrance guide that is rotatable around a rotation axis parallel to the second roller and guides the sheet that is about to enter the fixing nip; and
a hardware processor that controls a rotation position of the entrance guide around the rotation axis based on sheet stiffness information on a hardness of the sheet.

2. The fixing device according to claim 1, wherein the hardware processor controls the rotation position of the entrance guide such that as the sheet stiffness information is smaller, a leading end of the sheet enters a position more away from an entrance position of the fixing nip toward the second roller.

3. The fixing device according to claim 2, wherein the hardware processor,
in response to the sheet stiffness information being less than a threshold value, sets the rotation position of the entrance guide to a first rotation position that allows the leading end of the sheet to contact the second roller before entering the fixing nip, and
in response to the sheet stiffness information being equal to or greater than the threshold value, sets the rotation position of the entrance guide to a second rotation position that allows the leading end of the sheet to enter a position closer to the fixing nip as compared with the first rotation position.

4. The fixing device according to claim 1, wherein the sheet stiffness information includes one or more of a basis weight, a stiffness and a thickness of the sheet.

5. The fixing device according to claim 1, comprising a fixing belt that is disposed between the first roller and the second roller and forms the fixing nip with the second roller.

6. The fixing device according to claim 5, comprising a heating roller around which the fixing belt is stretched and that heats the fixing belt.

7. The fixing device according to claim 6, wherein the heating roller includes a heater disposed inside.

8. The fixing device according to claim 1, comprising:
a shaft parallel to the rotation axis;
a support that is disposed at one end of the shaft and rotates the entrance guide as the shaft rotates; and
a cam that is connected to another end of the shaft and rotates the shaft.

9. The fixing device according to claim 1, wherein the entrance guide is attachable and detachable.

10. The fixing device according to claim 1, wherein the fixing nip is configured such that a nip pressure is adjustable.

11. An image forming apparatus comprising:
an image former that forms the toner image;
a transferrer that transfers the toner image formed by the image former onto the sheet; and
the fixing device according to claim 1.

12. The image forming apparatus according to claim 11, wherein the transferrer is configured such that a transfer pressure with which the toner image is transferred onto the sheet is adjustable.

13. The image forming apparatus according to claim 11, comprising a setter that sets the sheet stiffness information based on a user operation.

14. A control method of a fixing device including a first roller, a second roller that faces the first roller to form a fixing nip and has a higher surface hardness than the first roller, and an entrance guide that is rotatable around a rotation axis parallel to the second roller and guides a sheet that is about to enter the fixing nip, the control method comprising:
controlling a rotation position of the entrance guide around the rotation axis based on sheet stiffness information on a hardness of the sheet.

15. A non-transitory computer-readable storage medium storing a program causing, of a fixing device including a first roller, a second roller that faces the first roller to form a fixing nip and has a higher surface hardness than the first roller, and an entrance guide that is rotatable around a rotation axis parallel to the second roller and guides a sheet that is about to enter the fixing nip, a computer to:
control a rotation position of the entrance guide around the rotation axis based on sheet stiffness information on a hardness of the sheet.
